(19) United States
(12) Patent Application Publication
(10) Pub. No.: US 2010/0262949 A1
(43) Pub. Date: Oct. 14, 2010

(54) Visualized Modeling Language Connector Selection

(75) Inventors: Jens Jacobsen, Seattle, WA (US); Andrew Jude Byrne, Redmond, WA (US); Ian Michael Bavey, Sammamish, WA (US); Jing "Frank" Fan, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/420,739

(22) Filed: Apr. 8, 2009

(51) Int. Cl. G06F 9/44

(52) U.S. Cl. 717/105

(57) ABSTRACT

An automatic relationship selector can be used with complex visualized modeling languages, such as Unified Modeling Language, to help users obtain appropriate relationship types for connectors. The selector automatically selects a connector relationship type based on relationship selection criteria which may include element types, an implicit default, an explicit default, and/or a heuristic default. A user can manually override automatically selected connector relationship type assignments. A helper lets a user set aggregation and other connector relationship properties. Automatic relationship type selection is done in-place while a connector is being positioned, to maintain the user interface's focus on the design diagram and avoid interrupting the user's design drafting flow.

### BACKGROUND

Modeling languages have been created to express structure, flow, and other information about software, organizations, and other systems which behave (at least in part) according to a set of rules. Modeling languages may be textual, graphical, or both. Textual modeling languages provide standardized keywords, which may have associated parameters, to represent concepts and relationships. Graphical modeling languages provide design diagrams with named symbols to represent concepts, and lines connecting the symbols to represent relationships between the concepts. Graphical modeling languages are sometimes known as visualized modeling languages, and their named symbols are sometimes known as elements.

### SUMMARY

Complex visualized modeling languages, such as Unified Modeling Language, provide flexible and detailed design support. However, their complexity also creates challenges, particularly for beginners. One aspect of visualized modeling language complexity is the choice of appropriate relationship types, as reflected in a multitude of different tools used to create different types of objects and relationships between them. Beginner users face an uphill struggle trying to learn what all of these tools actually do, and even seasoned users find themselves switching tools frequently, which can impede creation and modification of design diagrams.

Some embodiments discussed herein provide an automatic relationship selector. The automatic relationship selector automatically selects a connector relationship type for a connector between visualized modeling language elements, based on relationship selection criteria. Relationship selection criteria may include, for example, the element types of the visualized modeling language elements, an implicit default connector relationship type, an explicit default connector relationship type, and/or a heuristic default connector relationship type. An implicit default is established when a user creates a relationship of a first type and then expressly changes the first type to another type, which thus becomes an implicit default connector relationship type. An explicit default is established when a user expressly specifies that a type will be the default value for a relationship, thereby setting an explicit default connector relationship type. A heuristic default is established on the basis that one type is used more frequently than other types and is therefore chosen as a heuristic default connector relationship type. Some embodiments allow a user to manually override a connector relationship type which has been automatically selected by the automatic relationship selector. Some embodiments allow a user to set properties of a connector relationship type, such as aggregation, direction, ownership, and so on. Some embodiments perform automatic relationship type selection “in-place,” that is, during a connector's placement while maintaining the user interface's focus on the design diagram, to avoid interrupting the user's flow.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor, at least one memory, at least one visualized modeling language tool, and other items in an operating environment which may be present on multiple network nodes, and also illustrating configured storage medium embodiments;

FIG. 2 is a block diagram illustrating an automatic relationship selector in an example architecture;

FIG. 3 is a flow chart illustrating steps of some method and configured storage medium embodiments;

FIG. 4 is a simplified screen shot of an example diagram with two elements linked by an association connector, also showing a user interface relationship selector override mechanism;

FIG. 5 is a simplified screen shot continuing the example of FIG. 4, with the override mechanism in use;

FIG. 6 is a simplified screen shot continuing the example of FIG. 4, after the override mechanism has been used to change a property of the association connector;

FIG. 7 is a simplified screen shot of another example diagram with two elements linked by an association connector;

FIG. 8 is a simplified screen shot continuing the example of FIG. 7, after an aggregation property of the association connector has been changed;

FIGS. 9 and 10 collectively show a connectivity matrix for a smart connector in some embodiments;

FIGS. 11 and 12 collectively show a table of connector relationship type dependencies and delegations used in some embodiments; and

FIG. 13 shows Use Case connector relationship types employed in some embodiments.

### DETAILED DESCRIPTION

Overview

Visual design surfaces of modeling tools can be fluent applications that let a user explore and capture designs quickly, naturally and precisely. Ease of use is often experienced in surfaces that have very simple languages, such as mind mapping applications. However, in more complex languages, such as Unified Modeling Language (“UML”), the application sometimes gets in the way (UML specification is promulgated by the Object Management Group, a non-profit computer industry specifications consortium). To build even simple diagrams, a user invokes a multitude of different tools to create the different types of objects and relationships between them. As a consequence, beginner users struggle to learn what all of these tools do, and even seasoned users switch tools frequently while working, making the design process cumbersome and slow.

In particular, new UML users have difficulty finding the right type of relationship between elements. In UML, as in some other visualized modeling language, connectors define relationships between visualized modeling language elements. In UML, and some other languages, a wide variety of connector and element combinations are theoretically possible.

Some embodiments discussed herein help users build suitable relationships between objects (a.k.a. elements). In some cases, a correct relationship type between two objects/elements can be determined fully by inspecting the object/element types that are being connected. In some other cases, a suitable relationship type can be inferred to provide helpful default values.

Some embodiments described herein provide a smart connector tool which allows a user to create relationships that are automatically typed appropriately based on context. If only one type and/or direction is consistent with the visualized modeling language specification, that type and/or direction will be chosen. If multiple types are possible, a default type will be automatically chosen; the chosen type is a default in the sense that a user can change the type later using a smart tag or other user interface device as an override mechanism.

In some embodiments, the smart connector tool automatically selects the right type of relationship and direction, based on context, and sets it without user intervention. If the automatically chosen type does not meet the user's needs, the smart connector tool gives the user an in-place mechanism to change the type of relationship to another type that is suitable, given the context. Choices which are inconsistent with the visualized modeling language specification are generally suppressed.

In some embodiments, connection helpers provide commands in the user's terminology to help users select suitable relationship types and settings. In some embodiments, the smart connector is a single tool which allows the user to create all the relevant relation types for a given context. When the user does a gesture (drag, click, etc.) to create a relationship between two elements, the smart connector will assign a type to the relationship, based on the context. If only one relationship type is consistent with the visualized modeling language specification, that type will be chosen by the tool. If only one direction of relationship (source/target) is possible then that direction will be chosen by the tool, regardless of the direction of the gesture. If more than one relationship type is possible, a default type will be chosen by the tool, based on context (object types and prior user selections). A user-friendly selection mechanism such as a smart tag, keyboard action, or mouse action, for example, will be available on the relationship to change its type.

Keeping work flowing is a benefit, especially in design. Being forced to make decisions prematurely and/or learn new concepts about a tool in the midst of a design effort interrupts flow. With some embodiments, users can create relationships quickly and without interruption, even in complex visualized modeling languages. A beginner can ease into learning the intricacies of UML by using default relationships, and then changing the relationship type later as desired, by selecting from a filtered list of alternative types. Users looking for a quick drafting experience can ignore relationship types when starting out, knowing that most of the types will automatically be chosen correctly.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Code” means processor instructions, data (which includes constants, variables, and data structures), or both instructions and data.

“Element” is used herein as a technical term, as opposed to its use as a term of art in patent law, unless clearly indicated otherwise. Examples of elements thus include visualized modeling relationship elements such as a UML class, object, interface, use case, component, or node.

Throughout this document, use of the optional plural “(s)” means that one or more of the indicated feature is present. For example, “connector(s)” means “one or more connectors” or equivalently “at least one connector”.

Whenever reference is made to data or instructions, it is understood that these items configure a computer-readable memory thereby transforming it to a particular article, as opposed to simply existing on paper, in a person's mind, or as a transitory signal on a wire, for example.

Operating Environments

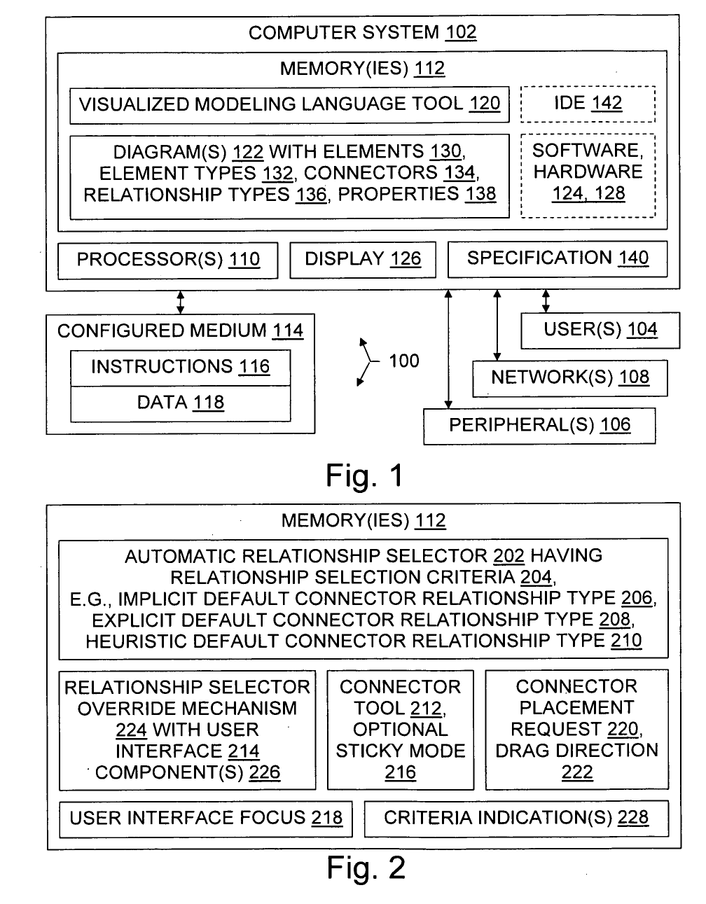

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked.

Human users 104 may interact with the computer system 102 by using display(s), keyboard(s), a mouse, tablet(s), microphone(s), speaker(s), motion sensor(s), and/or other peripherals 106. System administrators, system architects, designers, developers, engineers, project managers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example.

The computer system 102 includes at least one logical processor 110. The computer system 102, like other suitable systems, also includes one or more memories 112. The memories 112 may be volatile, non-volatile, fixed in-place, removable, magnetic, optical, and/or of other types. In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a memory 112. Other examples of memory 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the memory 112/medium 114 in which they reside; when that memory is a functional part of a given computer system, the instructions 116 and data 118 also configure that computer system. In some embodiments, a portion of the data 118 is representative of real-world items such as products, product characteristics, inventories, physical measurements, settings, images, readings, targets, volumes, and so forth. Such data is also transformed by as discussed herein, e.g., by connection, type assignment, type re-assignment, execution, modification, display, creation, loading, and/or other operations.

Memories 112 may be of different physical types. A visualized modeling language tool 120; diagrams 122 created, accessed, and modified through the tool 120; other software 124; and other items shown in the Figures may reside partially or entirely within one or more memories 112, thereby configuring those memories. An operating environment may also include a display 126, and other hardware 128 such as buses, power supplies, and accelerators, for instance.

The design diagrams 122 may include elements 130 which have associated element type(s) 132, and connector(s) 134 linking the elements 130. Connectors are sometimes called links. Each connector 134 has an associated relationship type 136, and each connector may have one or more associated properties 138. For convenience, properties 138 may be considered part of a relationship and/or part of a relationship's type. The available element type(s) 132 and relationship type(s) 136 are specified in a visualized modeling language specification 140, which can be embodied in the behavior of the tool 120 and/or set forth expressly by documentation in a human-readable file, for instance.

A given operating environment 100 may include an Integrated Development Environment (IDE) 142 which provides a developer with a set of coordinated software development tools. In particular, some of the suitable operating environments for some embodiments include or help create a Microsoft® Visual Studio® development environment (marks of Microsoft Corporation) configured to support program development. Some suitable operating environments include Java® environments (mark of Sun Microsystems, Inc.), and some include environments which utilize languages such as C++ or C# (“C-Sharp”), but teachings herein are applicable with a wide variety of programming languages, programming models, and programs, as well as with endeavors outside the field of software development per se that use visualized modeling language(s).

Some items are shown in outline form in FIG. 1 to emphasize that they are not necessarily part of the illustrated operating environment, but may interoperate with items in the operating environment as discussed herein. It does not follow that items not in outline form are necessarily required, in any Figure or any embodiment.

Systems

FIG. 2 illustrates an architecture which is suitable for use with some embodiments. An automatic relationship selector 202 operates to automatically select connector 134 characteristics, such as a connector's relationship type 136. The selection is automatic in the sense that the selection embodies more computational effort than merely listing types and accepting a user's input to select a type. Instead, the selection embodies decisions and suggestions by the implementers of the selector 202, which also take into account the context of the particular connector that is being placed in a diagram by the user.

The automatic selection of a connector's relationship is based on one or more relationship selection criteria 204. One criterion 204 that may be used is the element type(s) 132 of the elements 130 which are being connected by the connector 134. Other criteria which may be used include an implicit default connector relationship type 206, an explicit default connector relationship type 208, and a heuristic default connector relationship type 210, each of which is discussed in detail herein. Criteria 204 may be embodied in enumeration values, structs, methods, bits, and/or other criteria indications 228.

The automatic relationship selector 202 may be part of, or may interoperate with, a connector tool 212. The automatic relationship selector 202 embodies at least operational logic for selecting a connector relationship from multiple connector relationship types allowed by a specification 140. The connector tool 212 embodies at least a user interface 214 portion, including software, hardware (e.g., a display 126), or both.

In some embodiments, the connector tool 212 has a sticky mode 216 in which the connector tool remains visible and available to the user to place additional connectors, until the connector tool is expressly dismissed by the user. In a non-sticky mode, and in connector tools 212 which lack a sticky mode, the connector tool may be dismissed from the visible user interface right after the placement of a single connector.

During placement of a connector 134 by a user, the connector being placed is displayed, together with a diagram 122 the connector will become part of when placed. That is, a focus 218 of the user interface is the connector and its diagram, as opposed for example to focusing on a grid that specifies connector defaults in general.

A user gesture, such as activating the connector tool and dragging a prospective connector into the diagram, or hitting a key sequence that inserts a connector in the diagram, results in a connector placement request 220 which is accessible to the automatic relationship selector. The connector placement request may include data 118 such as the current insertion location in the diagram 122, and the element(s) 130 that have been selected (chosen explicitly and/or by proximity to the insertion location) to be connected by the connector. In some embodiments, the connector placement request may include a drag direction 222 specifying a vector tracking the user's gesture, e.g., when a connector may need a relationship type that indicates the connector goes from a first element to a second element.

In some embodiments, an automatically selected relationship type 136 can be changed by a user, via a relationship selector override mechanism 224. For example, a user may click a mouse button, a displayed icon, or another component 226 to obtain a list of alternate suitable relationship types which are also consistent with the language specification 140, and then select one using familiar user interface actions.

With reference to FIGS. 1 and 2, some embodiments provide a computer system 102 with a logical processor 110 and a memory 112 configured in operable communication with the logical processor by circuitry, firmware, and/or software to transform a user gesture into a connector having a suitable relationship type. A visualized modeling language tool 120 configuring a portion of the memory contains a diagram 122 including at least a first visualized modeling language element 130 having a first element type 132 and a second visualized modeling language element 130 having a second element type 132. A set of visualized modeling language connectors 134 is available in memory for defining relationships between visualized modeling language elements 130. An automatic relationship selector 202 is part of an extended tool 120 or operates in conjunction with a tool 120. The automatic relationship selector 202 is configured to automatically select a connector relationship type 136 for a connector 134 between the first visualized modeling language element 130 and the second visualized modeling language element 130, based on at least the following relationship selection criteria 204: the first element type 132, and the second element type 132, which may be the same as the first element type 132 in some instances (e.g., one class instance connecting to another class instance). An element may also connect to itself, e.g., one class instance connecting to itself.

Direction may also be a relationship selection criterion 204. For instance, a connection from a class element 130 to an interface element 130 in a logical class designer diagram 122 has a default connection type “interface realization” whereas a connection from an interface element 130 to a class element 130 has a default connection type “association”.

In some embodiments, the relationship selection criteria 204 include an implicit default connector relationship type 206. For example, suppose a connector C1 between elements of types T1 and T2 initially has relationship type R1, but the user changes the connector C1 to have relationship type R2. In response to the change, the system sets R2 as an implicit default connector relationship type for contexts involving T1 and T2. When the user subsequently makes a gesture to place a connecter C2 between two elements of types T1 and T2 (using the same element(s) or different elements), automatic relationship selector 202 sets R2 as the initial (default) relationship type for C2. The direction and/or other properties of a connector may also be part of the context.

In some embodiments, the relationship selection criteria 204 include an explicit default connector relationship type 208. For example, a user may be presented a grid, table, list, or other collection of default values for collectors in general. Element types serve as indexes to entries in the grid or other collection, and default relationship types serve as entry values. In a grid, for instance, the entry value Rmn at the intersection of row Tm and column Tn is the default relationship type for connectors between an element of type Tm and an element of type Tn.

In some embodiments, the relationship selection criteria 204 include a heuristic default connector relationship type 210. For example, suppose a connector C between elements of types T1 and T2 has relationship type R1 in sixty percent of some collection of examples accessed by a tool, has relationship type R2 in twenty-five percent of the examples, and has other relationship types in the remaining fifteen percent of the examples. The automatic relationship selector 202 accordingly sets R1 as the initial (default) relationship type for a connector C between elements of types T1 and T2. The examples may be obtained by automatically or manually tracking a single user, or by tracking a group of users, for instance. In a given embodiment, the heuristic default may have a lower priority (be overridden by) the implicit default, which in turn has a lower priority than the explicit default, for instance.

In some embodiments, a human user 104 operates graphical mechanisms, which in turn interface with the automatic relationship selector 202. In other embodiments, the user 104 is a software process, which interfaces with the automatic relationship selector 202 in a manner requiring little or no human input, at least as far as relationship type selection is concerned. For example, a program could interface with a ConnectionBuilder or other automatic relationship selector 202 through an API, passing source/target elements 130 and obtaining automatically selected relationship types, without requiring a graphical user interface.

In some embodiments, a user interface 214 records a drag direction for a placement of a given connector C1. The automatic relationship selector 202 then sets a relationship direction property of the connector to match the drag direction. For instance, if the user drags a cursor to create a connector C1 from element E1 to element E2, then the direction property of the connector C1 is set accordingly as pointing from E1 to E2.

Some embodiments include a relationship selector override mechanism 224, which is configured in some cases with a filtered list of relationship types. By selecting from the list, a user can manually override a connector relationship type which has been automatically selected by the automatic relationship selector 202. For instance, a context-based menu associated with a connector C1 between two elements E1, E2 may contain a list of all relationship types allowed by the language specification 140 for connectors between elements having the same type(s) as elements E1, E2. In some embodiments, the relationship selector override mechanism 224 includes a user interface component 226 such as a menu or other input device which is configured to allow a user to set at least one property of a connector relationship type.

Some embodiments provide a sticky mode 216 connector tool. In sticky mode, the tool remains active and ready to place connectors until the tool's active presence in the user interface focus 218 is expressly canceled by a user.

In some embodiments, the system includes multiple computers connected by a network. Networking interface equipment can provide access to networks 108, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

Methods

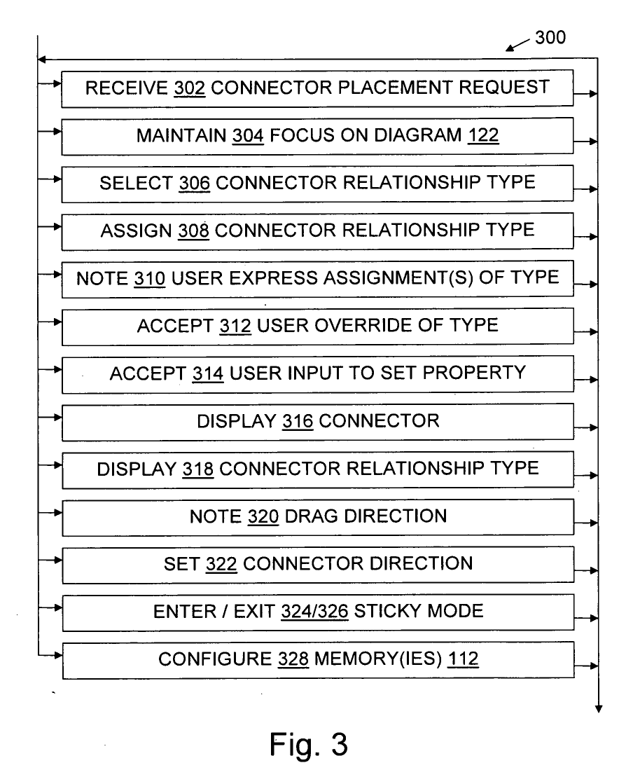

FIG. 3 illustrates some method embodiments in a flowchart 300. Methods shown in the Figures may be performed in some embodiments fully automatically, e.g., by an automatic relationship selector 202 in a visualized modeling language tool 120 operating under control of a script requiring little or no user input. Methods may also be performed in part automatically and in part manually unless otherwise indicated. In a given embodiment zero or more illustrated steps of a method may be repeated, perhaps with different parameters or data to operate on. Steps in an embodiment may also be done in a different order than the top-to-bottom order that is laid out in FIG. 3. Steps may be performed serially, in a partially overlapping manner, or fully in parallel. The order in which flowchart 300 is traversed to indicate the steps performed during a method may vary from one performance of the method to another performance of the method. The flowchart traversal order may also vary from one method embodiment to another method embodiment. Steps may also be omitted, combined, renamed, regrouped, or otherwise depart from the illustrated flow, provided that the method performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

During a gesture receiving step 302, also known as a connector placement receiving step 302, an embodiment receives a gesture from a user or receives a data structure indicative of such a gesture, requesting placement of a connector 134 in a diagram 122. Step 302 may be accomplished using code communicating with a user interface 214 such as a graphical user interface of a tool 120, or other mechanism, for example.

During a focus maintaining step 304, an embodiment maintains a user interface focus 218 on a diagram 122 to place and/or modify a connector 134. Focus would not be maintained, for example, if the embodiment switched user interface context from a particular connector that is being placed or modified, to a grid for entering explicit default values for connectors generally, that is, connectors which are not currently being placed and which may in fact never be placed in the particular diagram.

During a connector relationship selecting step 306, an embodiment automatically selects a connector relationship type 136 from multiple connector relationship types allowed by the visualized modeling language specification 140; properties 138 may be selected as part of step 306. Selection is accomplished using context such as element types 132, implicit defaults, explicit defaults, and/or heuristic defaults. In some embodiments, a “typeless” relationship type is available to users as a placeholder. For example, a user may be interested merely in connecting shapes, in a non-UML context or a context in which the validity of the model is not presently a priority for the user. The user could then change “typeless” relationships later to typed relationships that conform with a visualized modeling language specification 140.

During a connector relationship assigning step 308, an embodiment assigns a connector 134 a relationship type 136; properties 138 may be assigned as part of step 308. The assigned type may have been automatically selected or may have been entered specifically by a user for the particular connector.

During a user action noting step 310, an embodiment notes action(s) by a user to expressly assign 308 a relationship type 136, including the context of the action. Noted actions may subsequently serve as relationship selection criteria, in the form of an implicit default connector relationship type 206 and/or a partial basis for a heuristic default connector relationship type 210. Actions may be noted 310 by storing a representation of the action and the context in a struct, list, or other data structure.

During an override accepting step 312, an embodiment accepts through a user interface 214 a user action to override a default (i.e., previously assigned) connector relationship type 136. Step 312 may be accomplished, for example, using smart tags as discussed herein.

During a property setting step 314, an embodiment accepts through a user interface 214 a user action to set one or more properties 138 of a connector relationship type 136. Step 314 may be accomplished, for example, using smart tags as discussed herein.

During a connector displaying step 316, an embodiment visually displays in a screen, monitor, or other display 126 a graphical representation of a connector 134. The connector may be represented as a continuous line or other arc, a discontinuous line or other arc, in monochrome or color, with or without associated displayed property text and icons, and with or without selection highlighting, for example.

During a relationship type displaying step 318, an embodiment visually displays in a screen, monitor, or other display 126 a graphical representation of a connector relationship type 136. The relationship type may be represented as text and/or icons, and with or without highlighting, for example.

During a drag direction noting step 320, an embodiment notes a user's direction of movement in dragging a displayed connector. Noted directions may subsequently serve as relationship property values. Direction may be noted 320 by storing a representation of the direction in a struct, list, or other data structure.

During a direction setting step 322, an embodiment sets a relationship property value, using a default and/or a previously noted 320 direction.

During a sticky mode entering step 324, an embodiment connector tool 212 enters a sticky mode. Sticky mode may be entered as a default and/or by an explicit user command.

During a sticky mode exiting step 326, an embodiment connector tool 212 exits sticky mode. Sticky mode may be exited as a default (that is, a tool may startup not in sticky mode) and/or by an explicit user command.

During a memory configuring step 328, a memory 112 is configured by an automatic relationship selector 202, by default relationship type(s) 206, 208, 210, or otherwise in connection with automatic selection of visualized modeling language connector types as discussed herein.

The foregoing steps and their interrelationships are discussed in greater detail below, in connection with various embodiments.

Some embodiments provide a method for in-place visualized modeling language connector selection. From a user's perspective, the method proceeds in a displayed diagram 122 on which a user interface is focused. The method includes receiving a connector placement request 220 to place a visualized modeling language connector 134 between a first visualized modeling language element 130 having a first element type 132 and a second visualized modeling language element 130 having a second element type 132. In particular, and without excluding all other languages, the visualized modeling language may be Unified Modeling Language. In response to the connector placement request, and while continuing to maintain 304 user interface focus on the displayed diagram, the method automatically selects 306 a connector relationship type 136 for the connector. Selection is based on at least the first element type and the second element type. While continuing to maintain 304 user interface focus on the displayed diagram, the method then automatically assigns 308 the selected connector relationship type to the connector, and displays 316 the connector in the diagram.

In some embodiments, the connector relationship type for the connector is automatically selected 306 without any prior selection by a user of a relationship type for the connector.

In some embodiments, the connector relationship type for the connector is automatically selected 306 based on correspondences between relationship types and elements defined in a visualized modeling language specification 140. For instance, a specification may allow only one relationship type for a connector between elements of types T1 and T2, even though the specification allows multiple relationship types for a connector between elements of types T1 and T3.

In some embodiments, the connector relationship type for the connector is automatically selected 306 based on relationship selection criteria 204 which include an indication 228 that a user previously expressly assigned the same relationship type to another connector between two elements, such as two elements of the same type.

In some embodiments, the connector relationship type for the connector is automatically selected 306 based on relationship selection criteria which include an indication 228 that the selected relationship type is used more frequently than another relationship type between elements of the first element type and the second element type. The selected relationship type is used more frequently by at least one user in some cases, and by multiple users in other cases. Frequency may be measured across a single IDE session, or across multiple IDE sessions, in a particular embodiment.

In some embodiments, the method includes accepting 312 user input to manually override a connector relationship type which has been automatically selected 306, thereby changing the relationship type 136 of a connector 134 between visualized modeling language elements 130.

In some embodiments, the method includes accepting 314 user input to set at least one property 138 of a connector relationship type 136. In some, the method includes displaying 316 the connector and/or displaying 318 the connector relationship type (or an indication thereof) in place in the diagram 122. In some embodiments, a connector placement request has a drag direction noted 320 for a placement of the connector, and the connector is automatically selected 306 to have a relationship direction that matches the drag direction. Focus may be maintained 304 on the particular connector being placed, as opposed to connectors generally or connectors already placed, while the relationship type is selected 306 and assigned 308.

Configured Media

Some embodiments include a configured computer-readable storage medium 114, which is an example of a memory 112. Memory 112 may include disks (magnetic, optical, or otherwise), RAM, EEPROMS or other ROMs, and/or other configurable memory. The storage medium which is configured may be in particular a removable storage medium 114 such as a CD, DVD, or flash memory. A general-purpose memory 112, which may be removable or not, and may be volatile or not, can be configured into an embodiment using items such as default relationship types 206, 208, an automatic relationship selector 202, and an override mechanism 224, in the form of data 118 and instructions 116, read from a removable medium 114 and/or another source such as a network connection, to form a configured medium. The configured memory 112 is capable of causing a computer system to perform method steps for transforming data through connector relationship type selection and assignment as disclosed herein. FIGS. 1 through 3 thus help illustrate configured storage media embodiments and method embodiments, as well as system and method embodiments. In particular, any of the method steps illustrated in FIG. 3, or otherwise taught herein, may be used to help configure a storage medium to form a configured medium embodiment.

### ADDITIONAL EXAMPLES

Additional details and design considerations are provided below. As with the other examples herein, the features described may be used individually and/or in combination, or not at all, in a given embodiment.

Some embodiments may be suitable for inclusion in a product offering such as the Microsoft® Visual Studio® Team System Architecture 2010 product.

Some embodiments operate and provide features consistent with the following examples. Constraints used as examples are based on a particular interpretation of a Unified Modeling Language (UML) specification, and it will be understood that other interpretations may be possible. Capitalization is present in these examples (e.g., “Activity” versus “activity”, “Object” versus “object”) to emphasize that they are merely examples. The Examples do not necessarily cover the full scope of UML activity diagrams, UML relationship types, or other aspects of UML.

As to setting relationship type automatically, in at least one version of a Unified Modeling Language (UML) Activity diagram there are a number of different element types (e.g., seventeen in one Microsoft implementation) as well as three different connection types. The UML specification 140 specifies rules for which elements can be connected to which, using which type of connector. For example, two Action shapes (that is, Action elements 130) can only be connected using a Control flow (that is, a connector 134 having a Control relationship type 136). Two Object shapes can only be connected by an Object flow, and an Object and an Action can only be connected by an Object flow. In one Microsoft designer tool, a user does not have to learn all these details of which connectors can be used with which elements. Instead, the user employs a Connector tool 212 which includes an automatic relationship selector 202, as follows:
Select the Connector tool
Click and drag a connector from an Action shape to another Action shape
   A Control flow relationship is created
Select the Connector tool again
Click and drag a connector from an Object node to another Object node
   An Object flow is created
Click and drag a connector from an Action node to an Object node
   An Object flow is created

The Connector tool can also enter a “sticky mode” where the tool stays active until the user cancels it. As a result, a user can create a series of relationships quickly without selecting a tool each time.

As to setting a default relationship type which can then be changed, in the UML Class diagram, there are also a number of different elements and relationships, as well as constraints on which relationships can be created between which elements. These constraints are determined by the UML specification. Examples of constraints employed in one Microsoft implementation of the UML Class diagram include the following:
Import relationship can only be between two packages
Interface realization can only be between an interface and a class
The only possible relationship with a Comment is a comment link

However, this Class diagram does not have constraints as strict as the Activity diagram constraints. In some cases, multiple relationship types are possible between two element types in the Class diagram. However, in at least some of these cases, one of the available relationship types is used more than the others. For example:
The Enumeration element is most commonly connected with an Association
A relationship that points from a class to an interface is in most cases an Interface realization
A relationship between two packages is most commonly an Import

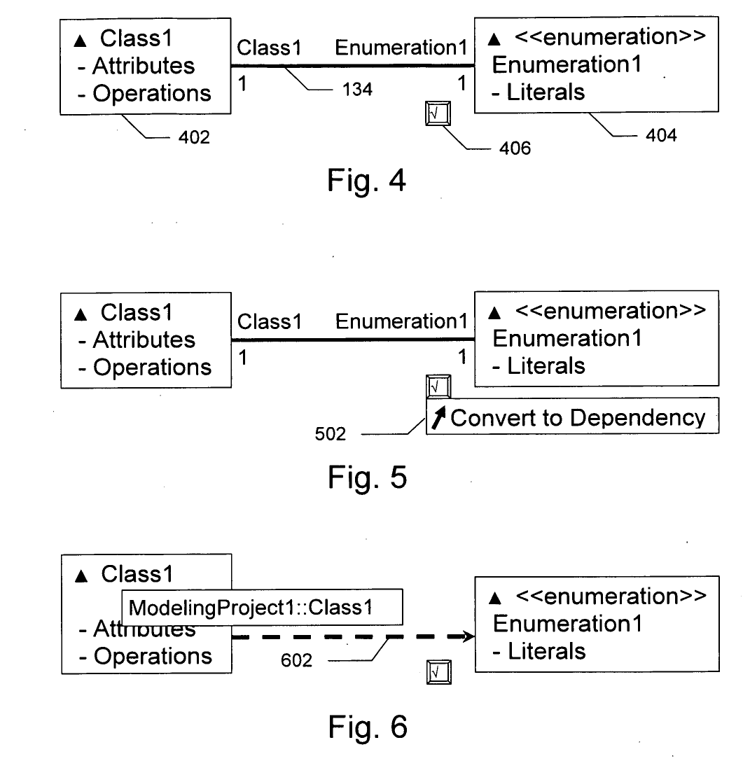

One system handles these cases by typing (assigning a type to) the connector with a default type based on context. The default type 136 can then be changed by the user as follows:
Select the Connector tool
Drag a connector between a Class 402 and an Enumeration 404, as illustrated in an example in FIG. 4
   An association is created between the Class and Enumeration elements
   When the association is selected, a smart tag 406 appears next to it
The user can click on the smart tag to change relationship type, as illustrated in FIG. 5
   Note that only one type shows up in the smart tag's filtered list 502 of available types, since classes and enumerations can only be related by association or dependency
If the user selects Convert to Dependency, the relationship is converted to a dependency 602, as illustrated in FIG. 6

As to an extension supporting user-determined defaults, in some embodiments for any given context which allows multiple relationship types, the system may let the user set the default, either implicitly or explicitly. When a user creates a relationship and then changes the type to another type, the system may store (note 310) the type setting and use the new type as an implicit default for the context. Explicit default settings could be exposed in a settings user interface component, letting the user determine the suitable settings.

In some embodiments, the connector tool 212 serves as a helper for setting connector properties 138. In a rich but general design language such as UML, the type of relationship assigned and detailed settings of the properties of a relationship can have rich semantic meaning, and the names used in the language specification 140 might not map easily to the user's domain. As a result, relationship types and settings can be quite hard for users to learn, and to remember.

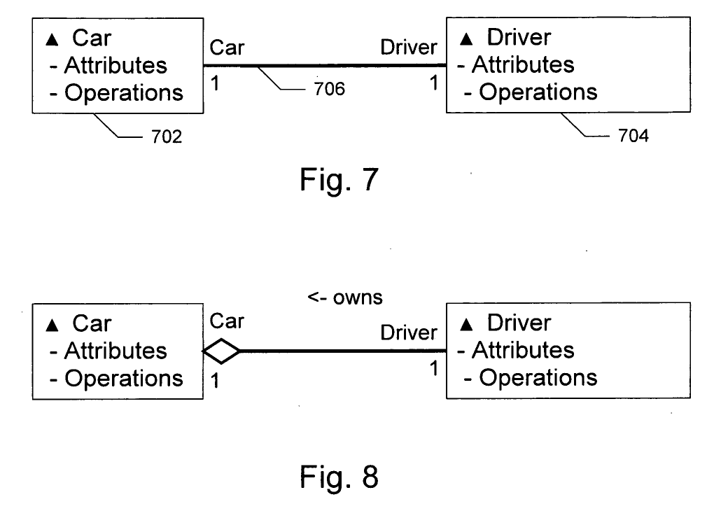

For instance, UML includes a relatively complex connector known as the Association connector. The Association relationship changes meaning based on its properties, and in particular based on the Aggregation property. For example, with classes Car 702 and Driver 704 illustrated in FIG. 7, the Association 706 can express the following:
Setting the Aggregation property to None on both ends of the relationship means that they are associated, so one could say something like “the car has a driver” and “driver has a car”
Setting the Aggregation of the Car to Shared is a stronger relationship, where one could say that the “driver owns a car”
Setting the Aggregation of the Car to Composite implies composition, meaning something like “Car is part of Driver”

Without Connector tool helpers, a user can be stuck trying to map the somewhat cryptic UML properties to whatever meaning the user wants to express. Connector tool helpers can be an extension to the Smart tag 406 of relationships (connectors) that let users set the properties 138 automatically by issuing commands that map more closely to the user's intent.

Continuing the example of FIG. 7, smart tag menu for the association between the Car and Driver class could look like this:
Convert to Inheritance
Convert to Dependency
Convert with Connection helper>
   (checked, since it is current) Car has Driver and Driver has Car
   Car owns Driver
   Driver owns Car
   Car is part of driver
   Driver is part of Car

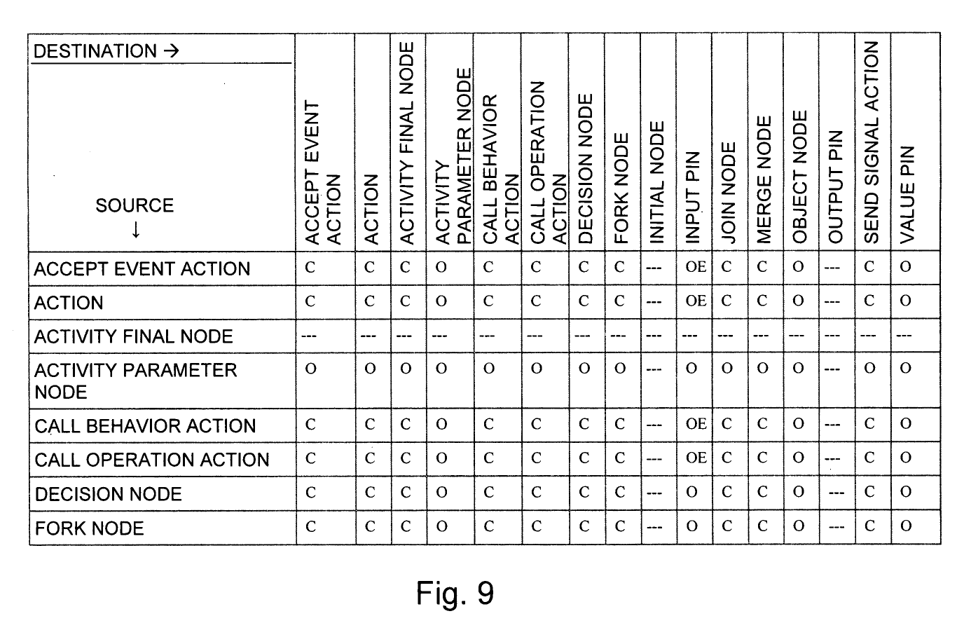

Selecting “Driver owns a Car” will cause the connector tool to set the Aggregation property of the association end of Car to Shared, and to add the name←owns (the arrow indicating reading direction) as well as add a visual indicator on the line, as illustrated in FIG. 8.

Commands such as those in the Car and Driver smart tag menu can help bridge a gap between a user's understanding of a problem domain and the UML syntax, and can also provide a quick way to set multiple properties 138. An additional benefit is that these embodiments of the connector tool 212 can help a user to easily validate the property settings, since the settings are expressed in a user readable form.

For additional examples, consider a Smart connector in an Activity diagram, that is, a connector associated with an automatic relationship selector 202. In terms of Object flows, suppose a user goal is to add an object flow to an activity diagram. A precondition is that the Activity diagram be open. Flow may proceed as follows:
User left-mouse selects the Object Node toolbox element from the Toolbox
With the left-mouse engaged, drags the element from the toolbox and releases the mouse button to drop a new object node onto the design surface.
User repeats previous operation to create an action.
User left mouse selects the Flow toolbox element from the Toolbox
User left-mouse selects Object1, then drags to Action1 and releases the mouse button to connect the objects.

A property involved is Name (string), having default value ObjectFlow1. Style varies by implementation; one style has Color: Black, Dash Style: Solid, Text Color: Black, and Thickness: 0.03125.

An Acceptance Test may include the following: Create new object flow on activity diagram by dragging from toolbox. Create new activity diagram. Create an object node and an action on diagram by dragging from toolbox. Create an object flow between the two shapes. Verify shape on diagram with proper size/shape/color/icon.

UML Constraints involved may include, for example:
Object flows may not have actions at either end.
Object nodes connected by an object flow, with optionally intervening control nodes, must have compatible types. In particular, the downstream object node type must be the same or a supertype of the upstream object node type.
Object nodes connected by an object flow, with optionally intervening control nodes, must have the same upper bounds.

In terms of Control flows, suppose a user goal is to add a control flow to an activity diagram. Again, a precondition is that the Activity Diagram be Open. Flow may proceed as follows:
User left-mouse selects the Action toolbox element from the Toolbox
With the left-mouse engaged, drags the element from the toolbox and releases the mouse button to drop a new Action onto the design surface.
User repeats previous operation to create a second action.
User left mouse selects the Flow toolbox element from the Toolbox
User left-mouse selects Action1, then drags to Action2 and releases the mouse button to connect the actions.
User notices that one can select the connector and begins typing to edit the Guard property.

Properties involved are Name (string) having Default value ControlFlow1, and Guard (string) displayed next to shape when set to non-empty string, in a display format such as “[Guard]”. Style may vary, including for example the style described above with Object flows.

An Acceptance Test may include the following: Create new control flow on activity diagram by dragging from toolbox. Create new activity diagram. Create two actions on diagram by dragging from toolbox. Create a control flow between the two actions. Verify shape on diagram with proper size/shape/color/icon.

In terms of a Smart connector in other kinds of visualized modeling language diagrams, consider the following difficulties. It is sometimes hard for inexperienced users to select the right type of connector. Connector types may be a barrier to a simple, drafting manner of using a tool 120. Some connectors (links) are highly specialized and may have only one use, but are given the same status in a toolbox as connectors that have multiple uses, e.g., a Reference link in Use Case, a Comment link in other diagrams. It can be helpful to reduce the trips a user makes to a toolbox when designing a diagram 122. Goals may include providing a quick and easy to use way to connect shapes in diagrams, automatically selecting a default connector, and letting users select between viable types where the choice of suitable link is ambiguous.

Accordingly, some embodiments provide a new tool on a toolbox, called “Connector”. When creating a connection using this tool, a user will get the following behavior, depending whether only one or more than one type of connector is possible between the two shapes. If only one type of connection is available consistent with the specification 140, then that connection is created. If two or more types of connections are available, then the Default connection is created and the connection gets a Smart tag with the ability to re-type the connection (e.g., when the user selects a new connection type, the embodiment deletes the old type assignment and creates a new type assignment).

A Toolbox icon for Smart Connector may be any suitable icon. One of the many suitable icons is a small right-angled arrow heading down and then to the right, in a colored background square. Some implementations use this right-angled arrow icon in Logical Class, Component, and Activity Diagrams to indicate smart connectors.

UML Constraints involved in an embodiment may include, for example, that Control flows may not have object nodes at either end, except for object nodes with control type.

To further illustrate embodiments and interaction between the user and an embodiment, consider the following story. Assume a user has Class1 and Class2 on a diagram 122, plus a comment for each of the classes.
The user hovers over the Connector tool in the toolbox
A tool tip appears saying:
   “Connection tool. Creates a default relationship between shapes, based on the types of shape being connected.”
The user clicks on Class1, and drags to Comment1
   A comment link is created
   No smart tag is present, since this relationship can only be of one type
The user creates a connection between Class1 and Class2
   The embodiment by default creates an Association
   A smart tag appears at the Target end of the relationship
The user wants to have an inheritance relationship instead, and therefore clicks on the Smart tag
   A list of available relationship types appear:
      Convert to Inheritance
      Convert to Dependency
The user selects Convert to Inheritance
   The relationship is changed to Inheritance.
   The Smart tag is still there, but collapsed
The user clicks on the Smart tag
   The user now sees the following options:
      Convert to Association
      Convert to Dependency
      - - -
      Override Operations
      Override all Operations
The user clicks on Convert to Dependency
   The relationship is changed to Dependency.
   The Smart tag is still there, but collapsed
The user clicks on the design surface to remove focus from the connector
   The Smart tag is hidden
The user clicks on the connector to give it focus
   The smart tag appears near the target
The user changes the Description property of the Dependency (or any property)
   The Smart tag disappears and will not be shown again, since the dependency now does not have any commands that are in scope

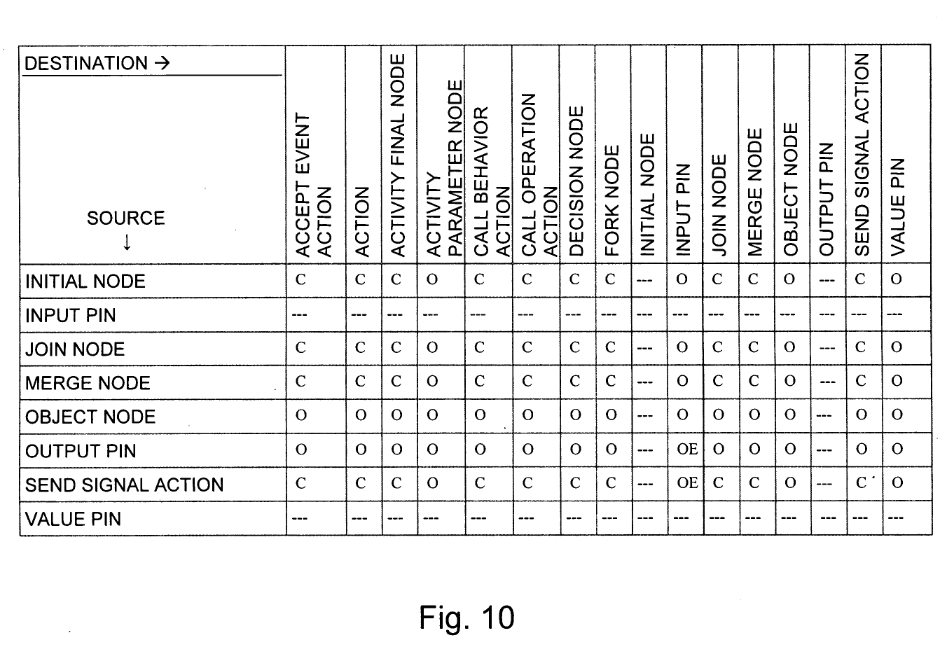

In some embodiments, a connector tool embodies constraints on UML relationship types which are consistent with the UML specification, as illustrated in FIGS. 9 and 10. In the smart connector connectivity matrix shown in FIGS. 9 and 10, C indicates elements that can be connected using a ControlFlowConnector, O indicates elements that can be connected using an ObjectFlowConnector, and OE indicates elements that can be connected using an ObjectFlowConnector or an ExceptionHandlerConnector. In some embodiments, a connectivity matrix is defined as a two-dimensional array, and code generation from a text template is used to create code that embodies the matrix logic. Code can then be regenerated after the matrix is changed, allowing greater flexibility during development.

With regard to connector direction, in some embodiments if only one direction is possible, the embodiment sets the connector to have that direction. If two directions are possible, the embodiment defaults to the direction indicated by the user's drag action. Some smart tags allow a user to change direction, but others do not. Some allow relationships such as Interface Realization to be initiated from either end, while others do not.

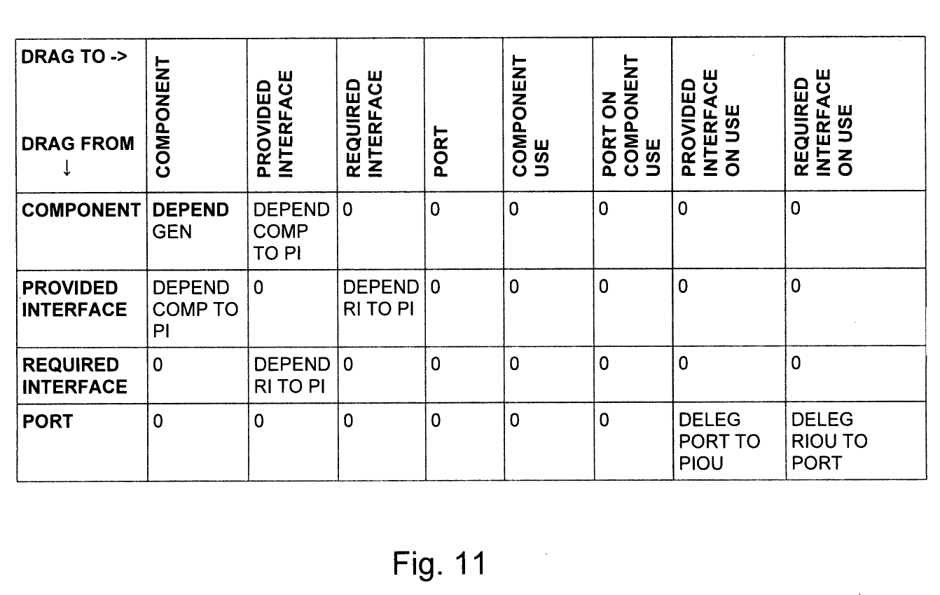

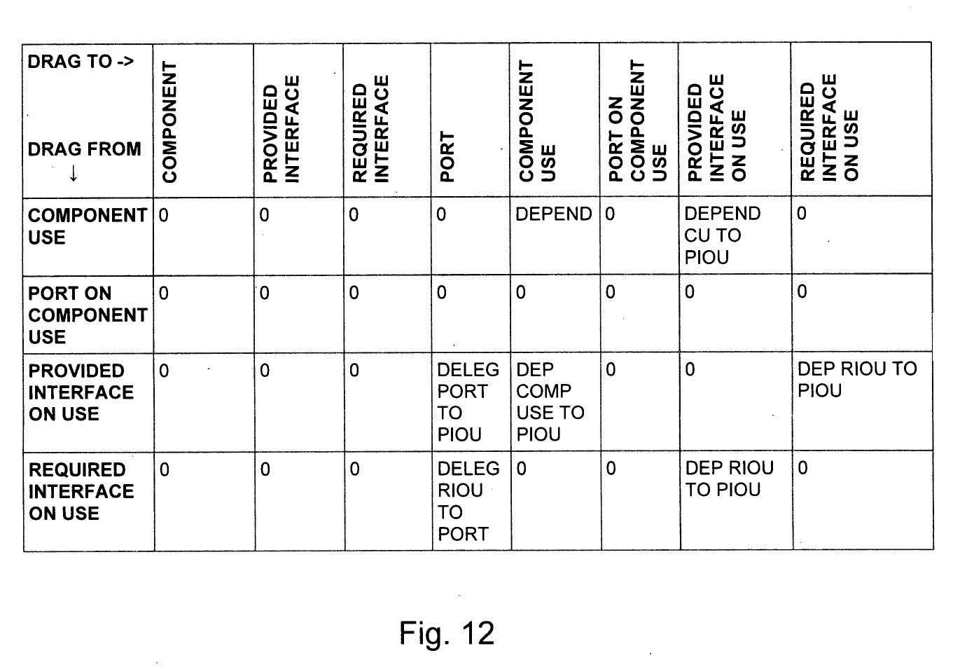

With regard to individual designers, in some embodiments connector relationship types have dependencies or delegations set as illustrated in a table shown in FIGS. 11 and 12 collectively. When an entry in the table has multiple values, e.g., drag from Component to Component, the value in bold is the default value. “Depend” stands for Dependency, “Deleg” stands for Delegation, “Gen” stands for Generalization, “Comp” stands for Component, and some elements are also abbreviated in table entries as acronyms, e.g., “Deleg Port to PIOU” stands for “Delegation from Port to Provided Interface on use”.

In some embodiments, a component use (and its owned ports and interfaces) can only connect to the owning component and to other component uses within the same component. That is, one cannot connect a use directly to something outside of the parent component. A component cannot connect to itself or to its own ports or interfaces. Likewise, a component use cannot connect to its owned ports or interfaces.

In some embodiments, with regard to sequence, a drag from a Life line to a Life line corresponds to Sync message, Async message, Create message. A drag from a Life line to/from a Comment corresponds to a Comment link.

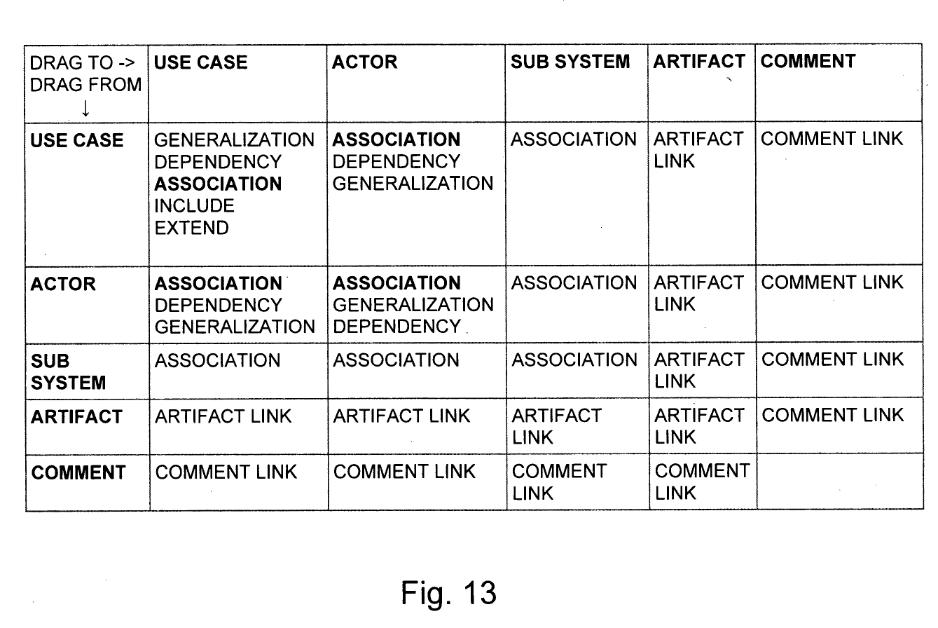

In some embodiments, with regard to a Use Case, relationships are typed as shown in FIG. 13; defaults are shown in Bold.

In some embodiments, with regard to layer, a drag from a Layer to a Layer corresponds to Dependency. A drag from a Layer to/from a Comment corresponds to a Comment link.

With regard to Connection helpers, one User story proceeds as follows when a user is working on a Logical Class Diagram:
Create two classes: Car and Driver
Select Smart Connector
Drag from Car to Driver
   An association is automatically created
   Click on smart tag. The following menu appears:
   Convert to Inheritance
   Convert to Dependency
   Connection helpers:
      Car has a driver (Association)
      Car owns a Driver (Aggregation)
      Driver owns a Car (Aggregation)
      Driver is a part of Car (Composition)
      Car is part of Driver (Composition)
User selects ‘Driver owns a Car’
   This sets the Aggregation property of the association end Car to “Shared”
   The diagram now shows a white diamond at the Driver end of the relationship

In some embodiments, a diagram is also a connectable element type. A particular example is the creation of lost/found messages in a sequence diagram.

### CONCLUSION

Although particular embodiments are expressly illustrated and described herein as methods, as configured media, or as systems, it will be appreciated that discussion of one type of embodiment also generally extends to other embodiment types. For instance, the descriptions of methods in connection with FIGS. 3 through 8 also help describe configured media, and help describe the operation of systems and manufactures like those discussed in connection with other Figures. It does not follow that limitations from one embodiment are necessarily read into another. In particular, methods are not necessarily limited to the tables or other data structures and arrangements presented here while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or methodological acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

What is claimed is:

1. A system comprising:
at least one logical processor;
a memory in operable communication with the logical processor;
a visualized modeling language tool configuring a portion of the memory, the tool containing a diagram including at least a first visualized modeling language element having a first element type and a second visualized modeling language element having a second element type;
a set of visualized modeling language connectors available in memory for defining relationships between visualized modeling language elements; and
an automatic relationship selector, configured to automatically select, from multiple connector relationship types allowed by a specification of the visualized modeling language, a connector relationship type for a connector between the first visualized modeling language element and the second visualized modeling language element based on at least all of the following relationship selection criteria: the first element type, the second element type.

2. The system of claim 1, wherein the relationship selection criteria also comprise an implicit default connector relationship type.

3. The system of claim 1, wherein the relationship selection criteria also comprise an explicit default connector relationship type.

4. The system of claim 1, wherein the relationship selection criteria also comprise a heuristic default connector relationship type.

5. The system of claim 1, further comprising a relationship selector override mechanism configured with a filtered list of relationship types to allow a user to manually override a connector relationship type which has been automatically selected by the automatic relationship selector, thereby changing the relationship type of a connector between visualized modeling language elements.

6. The system of claim 5, wherein the relationship selector override mechanism includes a user interface component configured to allow a user to set at least one property of a connector relationship type.

7. The system of claim 1, further comprising a sticky mode connector tool which remains active until expressly canceled by a user.

8. The system of claim 1, wherein the system also comprises a user interface having a drag direction for a placement of a given connector, and the automatic relationship selector sets a relationship direction property of the connector to match the drag direction.

9. A computer-readable medium configured with data and instructions for performing a method for in-place visualized modeling language connector selection, the method comprising the steps of:
for a displayed diagram on which a user interface is focused, receiving a connector placement request to place a visualized modeling language connector between a first visualized modeling language element having a first element type and a second visualized modeling language element having a second element type;
in response to the connector placement request, and while continuing to maintain user interface focus on the displayed diagram, automatically selecting from multiple connector relationship types allowed by a specification of the visualized modeling language a connector relationship type for the connector based on at least all of the following relationship selection criteria: the first element type, the second element type; and
while continuing to maintain user interface focus on the displayed diagram, automatically assigning the selected connector relationship type to the connector; and then
displaying the connector in the diagram.

10. The configured medium of claim 9, wherein the connector relationship type for the connector is automatically selected without any prior selection by a user of a relationship type for the connector.

11. The configured medium of claim 9, wherein an identifier naming the connector relationship type for the connector is automatically displayed adjacent the connector in the diagram.

12. The configured medium of claim 9, wherein the connector relationship type for the connector is automatically selected based on relationship selection criteria which also comprise an indication that a user previously expressly assigned the same relationship type to another connector between two elements of the first element type and the second element type.

13. The configured medium of claim 9, wherein the connector relationship type for the connector is automatically selected based on relationship selection criteria which also comprise an indication that the selected relationship type is used more frequently than another relationship type between elements of the first element type and the second element type, by at least one user.

14. The configured medium of claim 9, wherein the method further comprises accepting user input to manually override a connector relationship type which has been automatically selected, thereby changing the relationship type of a connector between visualized modeling language elements.

15. The configured medium of claim 9, further comprising accepting user input to set at least one property of a connector relationship type.

16. A method for in-place Unified Modeling Language connector selection, the method comprising the steps of:
receiving a connector placement request to place in a displayed Unified Modeling Language diagram a Unified Modeling Language connector between a first Unified Modeling Language element having a first element type and a second Unified Modeling Language element having a second element type;
in response to the connector placement request, automatically selecting from multiple connector relationship types allowed by a specification of the visualized modeling language a connector relationship type for the connector, without any prior selection by a user of a relationship type for the connector; and
displaying the connector in the Unified Modeling Language diagram.

17. The method of claim 16, further comprising displaying an indication of the automatically selected relationship type adjacent the connector in the Unified Modeling Language diagram.

18. The method of claim 16, wherein the connector relationship type for the connector is automatically selected based on an indication that a user previously expressly assigned the same relationship type to another connector between an element of the first type and an element of the second type.

19. The method of claim 16, wherein the connector relationship type for the connector is automatically selected based on an indication that the selected relationship type is used, by multiple users, between elements of the first element type and the second element type more frequently than another relationship type.

20. The method of claim 16, wherein the connector placement request has a drag direction for a placement of the connector, and the connector is automatically selected to have a relationship direction that matches the drag direction.
